(19) United States
(12) Patent Application Publication
(10) Pub. No.: US 2005/0146432 A1
(43) Pub. Date: Jul. 7, 2005

(54) Electronic personnel control and safety device

(76) Inventor: Antonio Perez Garcia, Sabadell (ES)

Correspondence Address: OSTROLENK FABER GERB & SOFFEN, 1180 AVENUE OF THE AMERICAS, NEW YORK, NY, 100368403, US

(21) Appl. No.: 10/507,138

(22) PCT Filed: Mar. 26, 2004
(86) PCT No.: PCT/ES04/00136

(30) Foreign Application Priority Data
May 14, 2003 (ES) P200301117

(51) Int. Cl. G08B 1/08

(52) U.S. Cl. 340/539.13; 340/573.1; 340/825.49

(57) ABSTRACT

Electronic equipment for safety and control of workers who work in risky conditions, which consists of data and voice repeaters that form a “guide line” that also act as an audible and visible reference in low visibility conditions, the repeaters communicating with the personalised devices attached to the arm of each fire fighter to indicate their state by means of a motion sensor. The personalised fire fighter devices also transmit to the repeaters the signals received from the pressure gauges for each fire fighter using the ABU's (autonomous breathing units). The signals sent by the repeaters are transmitted to the central system, which forwards them to a computer where all the information is displayed. The central system also emits signals to the fire fighters, either directly or through the repeaters. The personalised device turns on automatically when it detects motion.

### OBJECT OF THE INVENTION

The present invention relates to an electronic equipment for safety and control of workers who work in risky conditions, such as fire fighters, rescue teams or miners. It is conceived to control workers working to extinguish fires in households, large premises and particularly in garages, tunnels, underground trains and large enclosed spaces.

### BACKGROUND OF THE INVENTION

In cases in which there is a great distance between the entrance of the building and the location of the fire, autonomous air units are employed for breathing, as protection against the toxic fumes produced by combustion. These autonomous air units consist of compressed air bottles that provide air for a limited time. Therefore, a limited time is available to locate the fire and then reach the exit of the building.

An added hazard to work in risky conditions is the difficulty of communication with the exterior. Furthermore, there are no points of reference of the path followed and it is possible to become disoriented and be lost when trying to find the exit, as the work is performed in an unfamiliar place without illumination. Yet another disadvantage is that vision is severely impaired by the fumes.

The only control system for workers who work in risky conditions currently available consists of a table and a board. The safety manager located outside the building or area involved notes the workers and time of entry in the building on the board. Any fire fighter entering the premises, tunnel or underground train must hand in a personal badge to the safety manager. The latter will insert this badge in grooves made in the board and note its time of delivery. When the fire fighter exits the badge is returned to him or her. This system allows knowing the number of persons and time of permanence inside the building, premises, garage, tunnel, etc.

Another existing safety element consists of a pressure gauge coupled to the air bottle used to breathe in contaminated atmospheres. These pressure gauges indicate the air pressure inside the bottle and the remaining breathing time. They also indicate the external temperature and include a dead-man alarm. This information is not communicated to the exterior.

Currently, the demand for controlling workers working in risky conditions is not met as relates to their state and location. Also not resolved is the problem of communication with the exterior of the workers working inside buildings, basements, garages or tunnels.

### DESCRIPTION OF THE INVENTION

The electronic safety equipment proposed by the invention consists of a “guide line” comprised of transmitting-receiving repeaters operating in radio frequency transmitting certain messages that inform the central control unit of the state of the workers inside the affected area.

The full system comprises four differentiated parts:
a) Repeaters: modules based on which the “guide line” is formed.
b) Fire fighter unit: personalised unit attached to the arm of each fire fighter.
c) Pressure gauge: apparatus included in each compressed air breathing unit (ABU).
d) Central system: system that collects all transmissions and emits them towards a computer where all the information is analysed and displayed. It simultaneously sends information to the fire-fighter's personalised unit.

The equipment controls and locates at all times the workers working in risky situations from outside the building. The system is automatically activated from the beginning of the intervention by a personalised motion sensor carried by each fire fighter. The electronic unit enables both voice and data communication between the exterior and the interior. The pressure gauge informs the fire fighter of the air consumption and indicates the central system in the exterior the maximum time that the workers breathing with autonomous air units can remain inside. The internal working temperature is transmitted to the central system.

The repeaters incorporate an audible and visual signal to inform the fire fighter of the path followed, preventing him or her from becoming lost in a closed space, even with zero visibility. The “guide line” formed by the repeaters indicates the fire fighter the route to follow to exit the area, and shows others the route to follow to reach him or her.

The system detects from the outside whether a fire fighter needs help and informs of the location of this fire fighter, as each one is located by the position of the unit with respect to the nearest repeater. If a fire fighter remains in the same place for more than thirty seconds it will define the exact location. The electronic equipment controls, informs, detects and alerts the exterior at all times of the state and operation of the equipment. If a fire fighter is buried his precise location can be known by a receiver with a unidirectional antenna.

### DESCRIPTION OF THE DRAWINGS

To complement the description being made and in order to aid a better understanding of the characteristics of the invention, according to an example of a practical embodiment thereof, a single FIGURE is accompanied as an integral part of the description representing the electronic equipment for safety and control of workers disposed in a basement, showing the emergency workers (fire fighter) and the repeaters forming the “guide line”.

### PREFERRED EMBODIMENT OF THE INVENTION

The electronic equipment for safety and control of workers comprises four differentiated parts: repeaters, fire fighter units, pressure gauges and central system.

The repeaters transmit and receive data in the UN-39 frequency band, 869.3-869.4 MHz with 100 mW power and 25 KHz channelling. They can also act as voice repeaters when the fire fighter carries a radio transmitter (a walkie-talkie), maintaining voice communications with the exterior in places where this would not be possible without the repeater, due to the distance or physical barriers.

When a repeater is started, it must detect its position in the guide line. Each repeater is connected by radio with the adjacent repeaters. The repeater receives the information from the fire fighter's unit and transmits it upstream to the other repeaters toward the central system, transmitting the information generated by the central system downstream to the fire fighter units. The repeater is battery-operated. If one stops working or malfunctions, it is automatically eliminated and the chain is re-established with the nearest repeater assuming its functions, informing the central system of the modifications. Each repeater emits a flashing light.

The audible signals emitted by the repeaters comprise two types of beep: short beeps equivalent to one unit, and long beeps equivalent to five units. The first repeater will emit a short beep (.); the second one will emit two short beeps (..); the third one will emit three short beeps (...); the fourth one will emit four short beeps (....); the fifth one will emit one long beep (_); the sixth repeater will emit one long beep and one short beep (_.); and so on. The repeater audible signals will inform fire fighters of their position at all times, also providing orientation to know the direction to the exit or to another location.

The repeater has two buttons: one is to turn it on and the other is to enter the branching information in the “guide line”. The system allows branching of the “guide line” to allow a more thorough coverage of the premises. The repeater also verifies the temperature of the surroundings and sends it to the central system to control the temperature in the various areas in which work is being performed.

The personalised fire fighter's unit is turned on automatically with motion. It emits a sequence indicating that the fire fighter is OK whenever motion is detected. If no motion is detected, a sequence is sent to the central system indicating that a fire fighter is unconscious. If a fire fighter finds another fire fighter unconscious or needs help, a button on the personalised unit can be pressed to emit an SOS sequence to the central system. Each fire fighter shall have a personalised, non-transferable unit. The central system can send a sequence to the fire fighter(s) for immediate exit from the building, translated into a specific beeps signal. The fire fighter unit receives the data frames sent by the pressure gauge and sends them directly to the central system or to the nearest repeater in the direction of the central system. It is battery powered, and when the battery is low it informs the central system. At the end of the service it can be placed on stand-by mode by pressing the button three times, remaining in this state until it is set in motion.

The pressure gauge is automatically activated when the air valve of the ABU (autonomous breathing unit) is opened. It is provided with a LCD screen to inform of the pressure level, the remaining air time in minutes and the battery state. This information is transmitted by radio frames. When the ABU is turned on it must be assigned to the fire fighter using it (by approaching the pressure gauge of the ABU to a sensor in the personalised unit of the fire fighter). After this all the information sent by the pressure gauge by radio (ABU pressure, air consumption, remaining air time and battery state) will only be received by the personalised unit of the fire fighter using it, the latter unit then sending the information on its state and the information received from the pressure gauge to the central system, either directly or through the repeater closest to it.

The central system acts as a receiver for all the information received from the personalised units of the fire fighters, either directly or through the repeaters. It also receives and analyses the information obtained from the repeaters, which arrives from the nearest repeater. The central system also emits signals to the personalised unit, either directly or through the repeaters. In addition to personalised transmissions, it can perform collective transmissions to the personalised fire fighter units, such as the immediate exit signal.

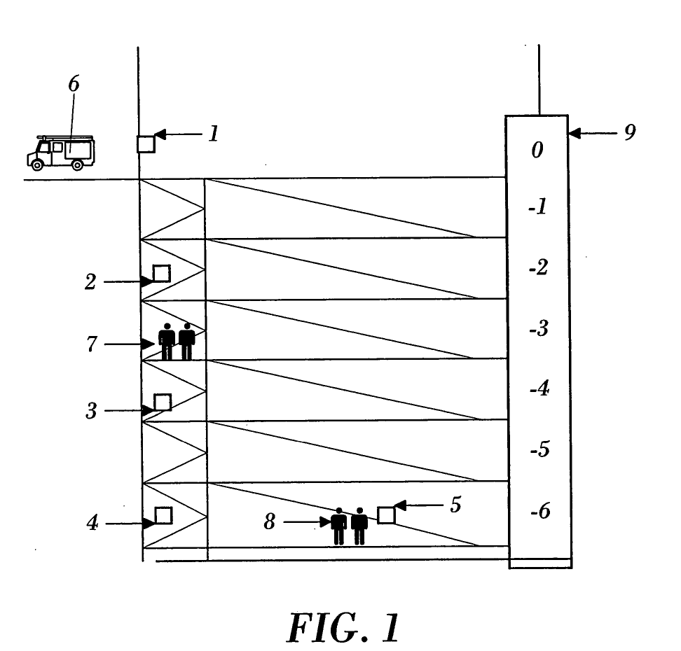

FIG. 1 shows the electronic equipment for safety and control of workers used in an emergency in a set of basements (a parking garage). The basements are numbered according to the reference (9). The central system is located in the fire truck (6). There are four fire fighters inside the parking lot, two in level −3 (7) and another two in level −6 (8). Each one is equipped with the persorialised unit that informs the nearest repeater (1, 2, 3, 4 and 5) of their state and provides the information received from the pressure gauge (pressure, remaining air time and ABU state). Each fire fighter's personalised unit is in constant communication with a repeater, which will be the one that receives the signal from the fire fighter unit most strongly (the nearest one).

In the situation of FIG. 1 the information received by the central system shall be that there are two fire fighters (7) located between the repeaters 2 and 3 and that another two fire fighters (8) are located near repeater 5. The personalised fire fighter units will inform on their state and air consumption if they are using ABU's. The various temperatures of the surroundings of the repeaters will also be sent to the central system.

1. Electronic equipment for safety and control of workers characterised in that it consists of:
a) repeaters: modules forming the “guide line”, which receive and transmit voice and data;
b) fire fighter units: personalised devices attached to the arm of each fire fighter that inform at all times on the status and location of the fire fighter and of the device itself;
c) pressure gauges: device provided in each autonomous breathing unit (ABU) that informs on the air pressure and remaining breathing time;
d) central system: unit that communicates with the personalised fire fighter units either directly or through the repeaters and analyses the information received with a computer.

2. Repeater according to claim 1, characterised in that it incorporates an audible signal by beeps (short and long) and a flashing visible signal that shows the fire fighter the way out, each repeater connected by radio with the adjacent repeaters of the “guide line” and with the nearby fire fighter units; transmitting information upstream from the fire fighter units or from other repeaters to the central system, and transmitting information downstream from the central system to the fire fighter units by the repeaters, acting as a voice repeater when the fire fighter carries a radio transmitter, and incorporating a thermometer whose measurement is sent to the central system.

3. Fire fighter unit according to claim 1, characterised in that it is automatically activated by a motion sensor and that emits, when the motion sensor is activated, a sequence indicating that the fire fighter is OK to the central system or to the nearest repeater, which then sends it to the central system; indicating that a fire fighter is unconscious when no motion is detected over a certain time; receiving the data frames sent by the pressure gauge when the fire fighter is using an ABU and sending them directly to the central system or through the nearest repeater, and receiving warnings from the central system.

4. Pressure gauge according to claim 1 that measures the air pressure and the air time in minutes remaining in the bottle and displays it together with the operational status of the pressure gauge itself in a LCD display, characterised in that it also sends this pressure, time and operational status information by radio to the personalised unit of the fire fighter assigned to it, this assignation performed at the start of consumption of the ABU air by approaching the pressure gauge to the personalised fire fighter unit.

5. Central system according to claim 1, characterised in that it receives the information from the personalised fire fighter units either directly or through the first repeater of the “guide line”, and which emits personalised or collective transmissions to the personalised fire fighter units either directly or through the first repeater.
